(19) United States
(12) Patent Application Publication
(10) Pub. No.: US 2024/0144113 A1
(43) Pub. Date: May 2, 2024

(54) METHOD AND NON-TRANSITORY COMPUTER READABLE MEDIUM

(71) Applicant: TOYOTA JIDOSHA KABUSHIKI KAISHA, Aichi-ken (JP)

(72) Inventor: Ippei IWAGASHIRA, Nagoya-shi (JP)

(21) Appl. No.: 18/493,803

(22) Filed: Oct. 25, 2023

(30) Foreign Application Priority Data
Oct. 26, 2022 (JP) 2022-171705

(51) Int. Cl. G06Q 10/02; G01C 21/36; G06Q 20/10; G06Q 30/0283

(52) U.S. Cl. CPC G06Q 10/02; G01C 21/3685; G06Q 20/102; G06Q 30/0284

(57) ABSTRACT

A terminal apparatus displays on a map, in a selectable manner, a plurality of open parking lots registered respectively by a plurality of service providers. Upon selection of an open parking lot by a user, the terminal apparatus displays a usage fee for the open parking lot. Upon completion of electronic payment of the usage fee for the open parking lot, the terminal apparatus displays completion of reservation of the open parking lot.

### CROSS-REFERENCE TO RELATED APPLICATION

This application claims priority to Japanese Patent Application No. 2022-171705 filed on Oct. 26, 2022, the entire contents of which are incorporated herein by reference.

### TECHNICAL FIELD

The present disclosure relates to a method and a non-transitory computer readable medium.

### BACKGROUND

Technology related to reserving open parking lots is known. For example, Patent Literature (PTL) 1 discloses technology to provide data for generating a visual representation of open parking spots on a map.

### CITATION LIST

### Patent Literature

PTL 1: US 2012/0265434 A1

### SUMMARY

In recent years, a plurality of businesses (hereinafter also referred to as “service providers”) have emerged to provide a service to accept registrations of parking lots from individual parking lot owners and to manage reservations for use of registered parking lots. However, conventional technology does not enable use of a single application to reserve open parking lots registered with a plurality of service providers. Such technology thus has room for improvement.

It would be helpful to improve technology related to reserving open parking lots.

A method according to an embodiment of the present disclosure is a method to be executed by a terminal apparatus according to an application program, the method including:
displaying on a map, in a selectable manner, a plurality of open parking lots registered respectively by a plurality of service providers;
displaying, upon selection of an open parking lot by a user, a usage fee for the open parking lot; and
displaying, upon completion of electronic payment of the usage fee for the open parking lot, completion of reservation of the open parking lot.

A non-transitory computer readable medium according to an embodiment of the present disclosure is a non-transitory computer readable medium storing an application program configured to cause a terminal apparatus to execute operations, the operations including:
displaying on a map, in a selectable manner, a plurality of open parking lots registered respectively by a plurality of service providers;
displaying, upon selection of an open parking lot by a user, a usage fee for the open parking lot; and
displaying, upon completion of electronic payment of the usage fee for the open parking lot, completion of reservation of the open parking lot.

According to an embodiment of the present disclosure, technology related to reserving open parking lots is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a diagram illustrating an example of a screen displayed on a terminal apparatus;

FIG. 3 is a block diagram illustrating a schematic configuration of the terminal apparatus;

FIG. 4 is a block diagram illustrating a schematic configuration of a first server;

FIG. 5 is a block diagram illustrating a schematic configuration of a second server;

FIG. 6 is a flowchart illustrating operations of the terminal apparatus; and

FIG. 7 is a flowchart illustrating operations of the terminal apparatus to execute an electronic payment process.

### DETAILED DESCRIPTION

Hereinafter, an embodiment of the present disclosure will be described.

### Outline of Embodiment

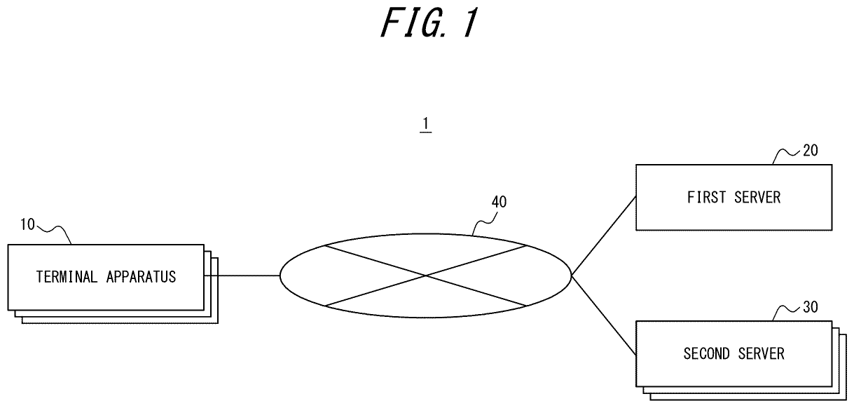

An outline of a system 1 according to an embodiment of the present disclosure will be described with reference to FIG. 1. The system 1 includes one or more terminal apparatuses 10, first servers 20, and second servers 30. Each terminal apparatus 10, the first server 20, and each second server 30 can communicate via a network 40 including, for example, the Internet and a mobile communication network.

The terminal apparatus 10 is a computer, such as a Personal Computer (PC), smartphone, or tablet terminal, for example, and is used by a user. The first server 20 is configured to include one computer or a plurality of computers that can communicate with each other. The first server 20 is managed by the operator of the dedicated application described below in the present embodiment, but this configuration is not limiting. The first server 20 may be managed by an affiliate of the operator, for example. The number of first servers 20 can be freely determined. The second server 30 is configured to include one computer or a plurality of computers that can communicate with each other. The second server 30 is managed by each service provider in the present embodiment, but this configuration is not limiting. The second server 30 may be managed by an affiliate of each service provider, for example. The number of second servers 30 can be freely determined.

In the present embodiment, a dedicated application program for the system 1 (hereinafter referred to as “dedicated application”) is installed on the terminal apparatus 10. The dedicated application has a parking lot reservation function. The “parking lot reservation function” is a function to display on a map, in a selectable manner, open parking lots associated with any points on a map, display a usage fee for a selected open parking lot, and provide an electronic payment procedure for the usage fee according to attribute information for the open parking lot to enable a user to reserve a desired open parking lot.

The information displayed for the selected open parking lot is not limited to the usage fee and may include any other information. For example, information including the positional information for the open parking lot, hours of operation, availability, or a combination of these may be displayed. These pieces of information can be stored on the first server 20 in the present embodiment but may be stored on the terminal apparatus 10.

Attribute information can include any information, other than the usage fee, about the open parking lot. For example, the attribute information may include information indicating whether the parking lot owner has passed a merchant screening for credit card payment. The “information indicating whether the parking lot owner has passed the merchant screening for credit card payment” is information that determines whether the payment procedure using the electronic payment function implemented in the dedicated application (hereinafter also referred to as the “first payment procedure”) can be provided as a procedure for electronic payment of the usage fee. Details are provided below.

The usage fee and attribute information for each open parking lot are stored on the first server 20 in the present embodiment, but one or both pieces of information may be stored on the terminal apparatus 10.

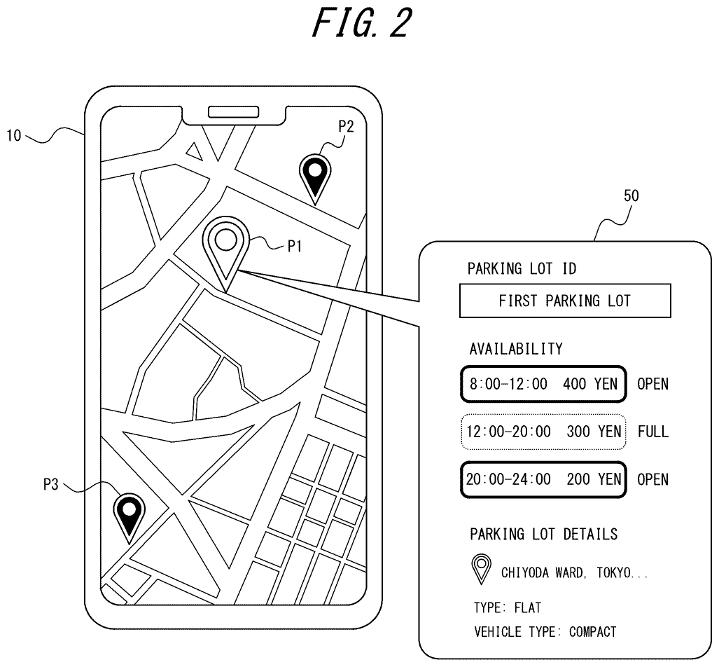

With reference to FIG. 2, an example of usage of the dedicated application is described. FIG. 2 illustrates an example of a screen displayed on the terminal apparatus 10 while the dedicated application is running in the foreground. In the example illustrated in FIG. 2, pins P1, P2, P3 indicating three open parking lots are displayed on the screen of the terminal apparatus as a plurality of open parking lots. Each open parking lot is indicated by a pin in FIG. 2, but this example is not limiting, and the open parking lots can be displayed in any identifiable manner. In the present embodiment, an “open parking lot” is, at the time of execution of the parking reservation function of the dedicated application, a parking lot among a group of parking lots, registered with respective service providers (hereinafter also referred to as “registered parking lots”), in which at least one vehicle can park for at least one unit of time during the operating hours of that parking lot. The user can use the parking reservation function to select an open parking lot by designating (for example, tapping a pin) any open parking lot on a map displayed on the screen of the terminal apparatus 10. Upon selection of an open parking lot, relevant information for that open parking lot (hereinafter also referred to as “open parking lot information”), including information corresponding to the usage fee in the present embodiment, is displayed on the screen of the terminal apparatus 10. In the example illustrated in FIG. 2, pin P1 is selected by the user, and open parking lot information 50 for the corresponding open parking lot is displayed.

In the example illustrated in FIG. 2, the open parking lot information 50 includes three items, i.e., “parking lot ID”, “availability”, and “parking lot details”, but is not limited to these items and can include any items. The term “ID” is an abbreviation of identifier. For example, the open parking lot information 50 may include an item indicating the distance from the open parking lot to the destination specified by the user.

The “parking lot ID” is any information that identifies the selected open parking lot. In the example illustrated in FIG. 2, the “parking lot ID” indicates the name of the open parking lot indicated by pin P1.

The “availability” indicates the reservation availability of the selected open parking lot for each time slot of use on the date on which the dedicated application is launched or on a date of use specified by the user. The reservation availability for each time slot of use can be indicated by any method. In the example illustrated in FIG. 2, time slots labeled “open” indicate reservable time slots, whereas time slots labeled “full” indicate times when reservations cannot be made. In other words, the operating hours of open parking lots include unit hours during which no parking reservations can be made. However, the display of the availability of each parking lot is not limited to these examples, and any appropriate method can be adopted. For example, availability may be indicated by attaching other labels, by varying the display color, or by displaying only information on reservable time slots. The availability may also include information indicating the number of vehicles for which a reservation may be made, i.e., the remaining number of available spaces.

In the example illustrated in FIG. 2, the “availability” indicates the usage fee along with the reservation availability for the selected open parking lot. The usage fee can be set freely. For example, for each open parking lot, the service provider to which the parking lot is registered may set the usage fee freely. The usage fee indicated by the “availability” corresponds to the usage fee for the open parking lot in the present embodiment.

The “parking lot details” indicate the location of the parking lot, the type (e.g., flat or multi-level parking), and the types of vehicles that can park, but these examples are not limiting.

The user can select and reserve a desired open parking lot from among a plurality of open parking lots by referring to the open parking lot information 50 for each open parking lot, as illustrated in FIG. 2, displayed on the screen of the terminal apparatus 10.

In addition to the parking lot reservation function, the dedicated application according to the present embodiment may have other optional functions, such as a route search function or a function to display peripheral information. Each function of the dedicated application may be realized by the terminal apparatus 10 alone or by cooperation between the terminal apparatus and the first server 20.

First, an outline of the present embodiment will be described, and details thereof will be described later. The terminal apparatus 10 executes the following operations according to the application program (dedicated application). The terminal apparatus 10 displays on a map, in a selectable manner, a plurality of open parking lots registered respectively by a plurality of service providers. Upon selection of an open parking lot by a user, the terminal apparatus 10 displays a usage fee for the open parking lot. Upon completion of electronic payment of the usage fee for the open parking lot, the terminal apparatus 10 displays completion of reservation of the open parking lot.

In this way, according to the present embodiment, a plurality of open parking lots registered respectively by a plurality of service providers are displayed on a map in a selectable manner. Thus, for example, a user can search a plurality of open parking lots registered with different service providers and can select and reserve a desired open parking lot by executing a single dedicated application on the terminal apparatus 10. Technology for reserving open parking lots is therefore improved in that it is easier to use a single application to reserve open parking lots registered with a plurality of service providers.

Next, configurations of the system 1 will be described in detail.

<Terminal Apparatus Configuration>

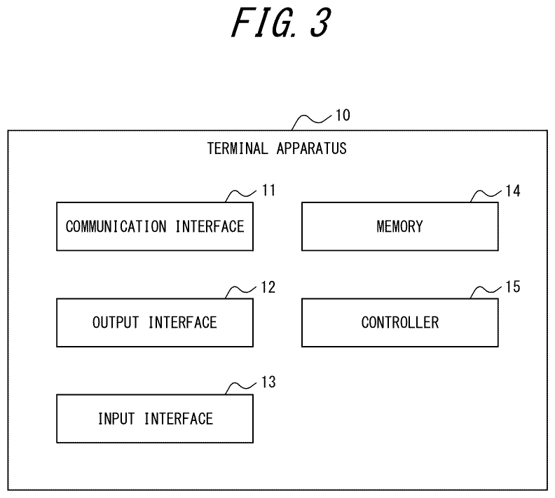

As illustrated in FIG. 3, the terminal apparatus 10 includes a communication interface 11, an output interface 12, an input interface 13, a memory 14, and a controller 15.

The communication interface 11 includes at least one communication interface for connecting to the network 40. The communication interface is compliant with mobile communication standards such as the 4th generation (4G) standard and the 5th generation (5G) standard, a wired local area network (LAN) standard, or a wireless LAN standard, for example, but is not limited to these, and may be compliant with any communication standard.

The output interface 12 includes at least one output device for outputting information. The output device is a display for outputting information as video, a speaker for outputting information as audio, or the like, for example, but is not limited to these. Alternatively, the output interface 12 may include an interface for connecting to an external output device.

The input interface 13 includes at least one input device for detecting an input operation by the user. The input device is a physical key, a capacitive key, a mouse, a touch panel, a touch screen integrally provided with a display of the output interface 12, a microphone, or the like, for example, but is not limited to these. Alternatively, the input interface 13 may include an interface for connecting to an external input device.

The memory 14 includes one or more memories. The memories are semiconductor memories, magnetic memories, optical memories, or the like, for example, but are not limited to these. The memories included in the memory 14 may each function as, for example, a main memory, an auxiliary memory, or a cache memory. The memory 14 stores any information to be used for operations of the terminal apparatus 10. For example, the memory 14 may store a system program, an application program, map information, or the like. In the present embodiment, the memory 14 stores the above-described dedicated application. The application program may be stored when the terminal apparatus 10 is manufactured or may be downloaded from an external application distribution server via the communication interface 11 and the network 40.

The controller 15 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these. The programmable circuit is, for example, a field-programmable gate array (FPGA), but is not limited to this. The dedicated circuit is, for example, an application specific integrated circuit (ASIC), but is not limited to this. The controller 15 controls the operations of the entire terminal apparatus 10.

In the present embodiment, the controller 15 transmits an inquiry request to the first server 20 via the communication interface 11 and the network 40 to inquire about various information, such as information about service providers or information about each registered parking lot. For example, the inquiry request could include data that inquires about relevant information (such as the usage fee) for each open parking lot selected by the user on the map in the dedicated application. The controller 15 can receive the relevant information for each open parking lot from the first server 20. Based on the received relevant information, the controller 15 can display each open parking lot on the map in a selectable manner, while generating open parking lot information 50, as illustrated in FIG. 2, for each open parking lot selected by the user and displaying the open parking lot information 50 on the dedicated application.

<Configuration of First Server>

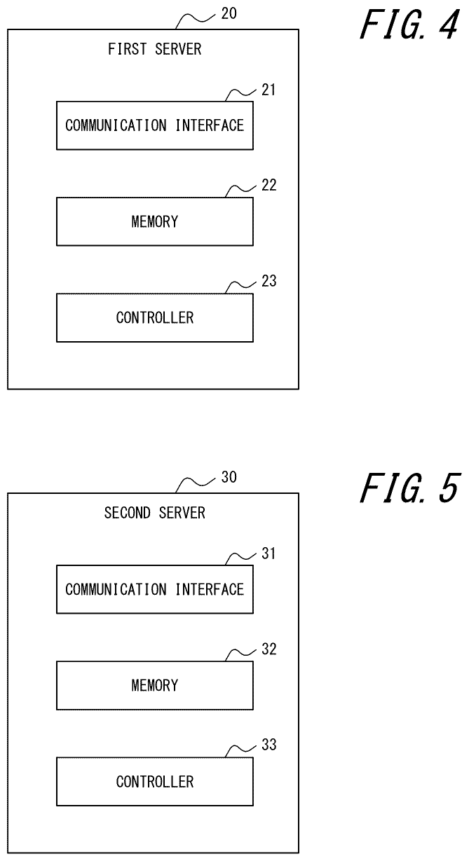

As illustrated in FIG. 4, the first server 20 includes a communication interface 21, a memory 22, and a controller 23.

The communication interface 21 includes at least one communication interface for connecting to the network 40. The interface for communication is compliant with, for example, a mobile communication standard, a wired LAN standard, or a wireless LAN standard, but is not limited to these, and may be compliant with any communication standard.

The memory 22 includes one or more memories. The memories included in the memory 22 may each function as, for example, a main memory, an auxiliary memory, or a cache memory. The memory 22 stores any information used for operations of the first server 20. For example, the memory 22 may store a system program, an application program, map information, embedded software, a database, and the like.

In the present embodiment, the memory 22 stores a database (hereinafter also referred to as the “first database”) for storing various information including information about the service providers managing the second servers 30 and information about each registered parking lot. The “information about the service provider” may include the identification information for the service provider (such as a service provider ID), the Uniform Resource Locator (URL) of the reservation and payment page described below, or both. The “information about each registered parking lot” may include identification information (such as a parking lot ID), usage fee, attribute information, or a combination of these for each registered parking lot.

The controller 23 includes at least one processor, at least one programmable circuit, at least one dedicated circuit, or a combination of these. The controller 23 controls operations of the entire first server 20.

In the present embodiment, the controller 23 receives, from the second server 30 managed by each service provider, various information, such as information about the service provider or information about each registered parking lot, via the communication interface 21 and the network 40. The controller 23 stores the received information in the first database of the memory 22. In response to an inquiry request from the terminal apparatus 10, the controller 23 can search the first database to read the information indicated in the inquiry request and transmit the information to the terminal apparatus 10.

<Configuration of Second Server>

As illustrated in FIG. 5, the second server 30 includes a communication interface 31, a memory 32, and a controller 33.

The communication interface 31 includes at least one communication interface for connecting to the network 40. The interface for communication is compliant with, for example, a mobile communication standard, a wired LAN standard, or a wireless LAN standard, but is not limited to these, and may be compliant with any communication standard.

The memory 32 includes one or more memories. The memories included in the memory 32 may each function as, for example, a main memory, an auxiliary memory, or a cache memory. The memory 32 stores any information used for operations of the second server 30. For example, the memory 32 may store a system program, an application program, embedded software, a database, and the like.

In the present embodiment, the memory 32 stores a database (hereinafter also referred to as the “second database”) for storing various information including information about the service provider managing the second server 30 and information about each registered parking lot.

The controller 33 includes at least one processor, at least one programmable circuit, at least one dedicated circuit, or a combination of these. The controller 33 controls operations of the entire second server 30.

In the present embodiment, the controller 33 transmits various information read from the second database of the memory 32 to the first server via the network 40. In addition, as described below, the controller 33 provides the second payment procedure of the present embodiment to the terminal apparatus 10 of the user.

<Operations of Terminal Apparatus>

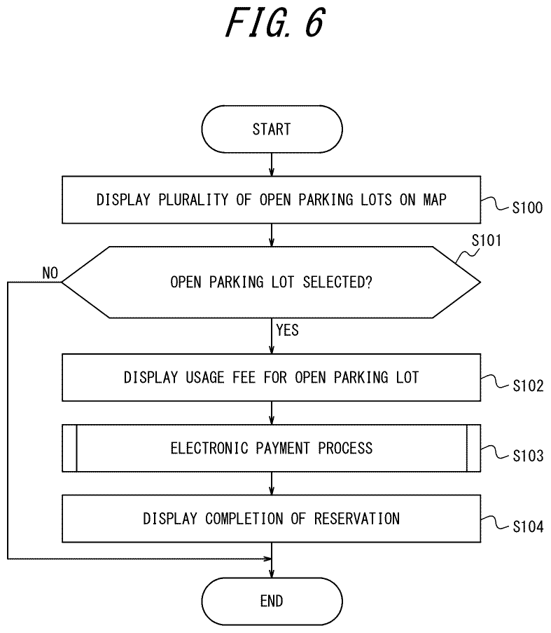

With reference to FIG. 6, the operations executed by the terminal apparatus 10 according to the dedicated application are described. The operations in FIG. 6 correspond to a method according to the present embodiment. These operations are, for example, initiated in response to the user operating the terminal apparatus 10 to launch the dedicated application, but the conditions and/or timing for initiating these operations are not limited to the present example.

Step S100: the controller 15 of the terminal apparatus 10 displays on a map, in a selectable manner, a plurality of open parking lots registered respectively by a plurality of service providers. The displayed map is a map of the area surrounding the destination designated by the user in the present embodiment, but this example is not limiting. The map may be a map of any location, such as a map around the position of the terminal apparatus 10.

Specifically, while the dedicated application is running in the foreground, the controller 15 displays a map of the area surrounding the destination designated by the user on the screen of the terminal apparatus 10 and displays, on the map, open parking lots in a selectable (for example, tappable) manner (see FIG. 2). The map may be generated based on map information stored in the memory 14, or map information acquired from the first server 20, and may then be displayed on the screen of the terminal apparatus 10.

The open parking lots displayed here are, at the time of execution of the parking reservation function of the dedicated application, parking lots in which at least one vehicle can park for at least one unit of time (for example, 20 minutes) during the operating hours of the parking lots, as described above. The operating hours and availability for each unit of time of each parking lot (hereinafter also referred to as “availability”) are associated with each parking lot in the present embodiment and stored in the memory 22 of the first server 20 but may also be stored in the memory 14 of the terminal apparatus 10. The controller 15 can acquire the availability of each parking lot from the first server 20 via the communication interface 11 and the network 40. The controller 15 can identify at least one parking lot that can accommodate at least one vehicle for at least one unit of time during operating hours by referring to the availability of each parking lot. The controller 15 displays the identified parking lots on the map as open parking lots. In the example illustrated in FIG. 2, the controller 15 displays pins P1, P2, P3 indicating three open parking lots on the map as a plurality of open parking lots. In this case, at least two of the three open parking lots are assumed to be registered to different service providers.

In this way, via a single dedicated application, the controller 15 can display on a map, in a selectable manner, a plurality of open parking lots registered respectively by a plurality of service providers.

Step S101: the controller 15 determines whether an open parking lot has been selected by the user. In a case in which an open parking lot has been selected by the user (S101: Yes), the process advances to step S102. In a case in which no open parking lot is selected by the user (S101: No), the process ends.

Specifically, the controller 15 can determine that an open parking lot has been selected in a case in which designation of (for example, tapping on) any open parking lot by the user on the map is detected via the input interface 13. In the example illustrated in FIG. 2, in a case in which it is detected that the user has tapped pin P1, the controller 15 can determine that the open parking lot indicated by pin P1 has been selected.

Step S102: in a case in which an open parking lot is selected by the user (step S101: Yes), the controller 15 displays the usage fee for the open parking lot.

Specifically, the controller 15 inquires to the first server 20 via the communication interface 11 and the network 40 about the usage fee for the open parking lot selected on the map by the user (open parking lot indicated by pin P1 in the example illustrated in FIG. 2). The controller 15 receives information, from the first server 20 via the communication interface 21 and the network 40, indicating the usage fee associated with the corresponding open parking lot. The controller 15 then generates open parking lot information 50, as illustrated in FIG. 2, based on the received information and displays the open parking lot information 50 on the screen of the terminal apparatus 10. In the example illustrated in FIG. 2, the controller 15 displays, on the screen of the terminal apparatus 10, information that includes the usage fee for the open parking lot indicated by pin P1. The usage fee can be displayed in any format, but in the example illustrated in FIG. 2, the usage fee is displayed as a usage fee per unit of time for each time slot of use.

The user may check the usage fee for the open parking lot displayed on the screen of the terminal apparatus 10 (the open parking lot indicated by pin P1 in the example illustrated in FIG. 2) and decide whether to make a reservation. The user may select another open parking lot displayed on the map (by tapping pin P2 or P3 in the example illustrated in FIG. 2) and compare the usage fees and other information. In this way, the user can select the open parking lot and parking conditions (such as time slot of use) for which the user wishes to make a reservation from among a plurality of open parking lots.

Step S103: the controller 15 executes an electronic payment process.

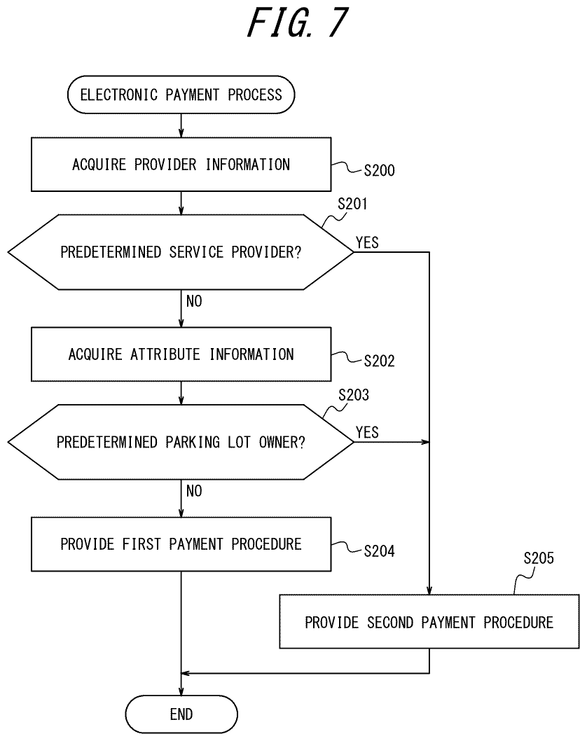

Specifically, the controller 15 executes the electronic payment process through the operations described below in FIG. 7. Upon completion of the electronic payment process in the present embodiment, electronic payment of the usage fee for the open parking lot is completed, and reservation of the open parking lot is confirmed.

Step S104: upon completion of electronic payment of the usage fee for the open parking lot, the controller 15 displays completion of reservation of the open parking lot.

Specifically, in a case of detecting that the electronic payment process has been completed for the desired parking lot selected in step S101, the controller 15 presents the user with information indicating completion of the reservation of an open parking lot. Any method can be employed to present such information. For example, the message “reservation completed” may be displayed on the dedicated application.

With reference to FIG. 7, operations of the terminal apparatus 10, which executes the electronic payment process described above in step S103, are explained. The operations in FIG. 7 correspond to a method according to the present embodiment.

Step S200: the controller 15 of the terminal apparatus 10 acquires provider information indicating the service provider that has registered each open parking lot.

Specifically, the “provider information” includes information (here, a flag) indicating whether the attribute information acquired in step S202, described below, is provided to the operator of the dedicated application (hereinafter also referred to as “whether attribute information is shared”). Any method can be employed to acquire the provider information. For example, the provider information may be collected by the first server 20 from the second server 30 of each service provider and stored in the first database. In this case, the controller 15 of the terminal apparatus 10 can refer to the first server 20 to acquire provider information on the service provider that has registered each open parking lot.

Step S201: the controller 15 determines whether the service provider that has registered the open parking lot selected by the user is a predetermined service provider based on the provider information acquired in step S200. The “predetermined service provider” is a service provider that does not provide the attribute information acquired in step S202, described below, to the operator of the dedicated application (first server 20) in the present embodiment. For example, a service provider that does not share attribute information with the operator for some reason, such as a service provider that does not have a system environment in place to provide attribute information, could correspond to a predetermined service provider. In a case in which the open parking lot is determined to be registered to a predetermined service provider (S201: Yes), the process advances to step S205. Conversely, in a case in which the open parking lot is determined not to be registered to a predetermined service provider (S201: No), the process advances to step S202.

Specifically, the controller 15 can determine whether the service provider that has registered the open parking lot selected by the user is a predetermined service provider by referring to the information (here, a flag), included in the acquired provider information, that indicates whether the attribute information of each service provider is shared.

Step S202: in a case in which it is determined that the open parking lot is not registered to a predetermined service provider (Step S201: No), the controller 15 acquires information indicating whether the parking lot owner has passed a merchant screening for credit card payment as the attribute information for each open parking lot.

Any method can be employed to acquire the attribute information for each open parking lot. For example, the attribute information may be collected by the first server 20 from the second server 30 of each service provider and stored in the first database. In this case, the controller 15 of the terminal apparatus 10 can refer to the first server 20 to acquire the attribute information on each open parking lot.

As described above, the “information indicating whether the parking lot owner has passed the merchant screening for credit card payment” is information that determines whether the first payment procedure using the electronic payment function implemented in the dedicated application can be provided as a procedure for electronic payment of the usage fee. In the present embodiment, in a case in which the parking lot owner has passed the merchant screening for credit card payment, the first payment procedure is provided as the procedure for electronic payment of the usage fee. Conversely, in a case in which the parking lot owner has not passed the merchant screening for credit card payment, a second payment procedure that differs from the first payment procedure is provided as the procedure for electronic payment of the usage fee. The “second payment procedure” is a payment procedure using an electronic payment function implemented on a website provided by the service provider that has registered each parking lot. Specifically, the controller 15 executes the operations in steps S203 through S205 below.

Step S203: the controller 15 determines whether the owner of the open parking lot is a predetermined parking lot owner. The “predetermined parking lot owner” is a parking lot owner who has not passed the merchant screening for credit card payment in the present embodiment. In a case in which the open parking lot owner is determined to be a predetermined parking lot owner (S203: Yes), the process advances to step S205. Conversely, in a case in which the open parking lot owner is determined not to be a predetermined parking lot owner (S203: No), the process advances to step S204.

Any method can be employed to determine whether the owner of the open parking lot is a predetermined parking lot owner. For example, information (here, a flag) indicating whether the merchant screening for credit card payment has been passed by each parking lot owner may be stored in the first database of the first server 20. In this case, the controller 23 of the first server 20 can, for example in response to an inquiry request from the terminal apparatus 10, determine whether the owner is a predetermined parking lot owner by searching the first database with the owner ID of the open parking lot owner as a query and referring to the flag. The controller 23 transmits the result of the determination to the terminal apparatus 10 via the network 40. The controller 15 of the terminal apparatus 10 can determine whether the owner of the open parking lot is a predetermined parking lot owner according to the received result of the determination.

Step S204: in a case in which it is determined that the owner of the open parking lot is not a predetermined parking lot owner (step S203: No), the controller 15 provides the first payment procedure as the procedure for electronic payment of the usage fee for the open parking lot. In other words, the first payment procedure is provided in a case in which conditions are met, i.e., the open parking lot is not registered to a predetermined service provider (step S201: No) and the owner of the open parking lot is not a predetermined parking lot owner. The first payment procedure is a payment procedure using the electronic payment function implemented in the dedicated application, as described above.

Any method can be employed to provide the first payment procedure. For example, a reservation button for reserving an open parking lot, a payment button for electronic payment of the usage fee, and an OK button for confirming the reservation may be displayed as icons on the dedicated application.

When it is detected that the user has tapped the reservation button, an input field (hereinafter also referred to as the “first input field”) that enables the user to input information such as the time slot of use of the open parking lot and the identification information of the vehicle to be parked (for example, a vehicle number) may be displayed on the screen of the terminal apparatus 10. The time slot of use may, for example, be inputted by the user selecting a desired time from a list of reservable time slots.

When it is detected that the user has tapped the payment button after information is inputted to the first input field, an input field (hereinafter also referred to as “second input field”) that enables the user to enter information on a payment method (such as credit card information) may be displayed on the screen of the terminal apparatus 10. The information on the payment method may be registered at any time, such as during the initial setup of the dedicated application. In this case, a list of registered payment methods is displayed in the second input field, and the user can input the information on the payment method by designating a desired payment method from the list. In a case in which an insufficient balance on a prepaid card or other payment method is detected at this time, the screen may be transitioned to a balance recharging screen to enable the user to recharge the balance of the corresponding payment method.

After inputting the information on the payment method in the second input field, the user can complete electronic payment for the open parking lot on the dedicated application by tapping the OK button. This confirms the reservation of the open parking lot. The first payment procedure of the present embodiment can thus be provided. In a case in which the controller 15 detects that the OK button has been tapped by the user, the controller 15 can determine that the electronic payment process is complete.

Step S205: in a case in which it is determined that the open parking lot is registered to a predetermined service provider (step S201: Yes), or it is determined that the open parking lot is not registered to a predetermined service provider and the owner of the open parking lot is a predetermined parking lot owner (step S203: Yes), the controller 15 provides a second payment procedure as the electronic payment procedure for the usage fee. The second payment procedure is, as described above, a payment procedure using an electronic payment function implemented on a website provided by the service provider that has registered each parking lot.

Any method can be employed to provide the second payment procedure. For example, when it is detected that the user has tapped the reservation button described above in step S204, the controller 15 may switch the application program running in the foreground. Specifically, the controller 15 can switch the application program running in the foreground from the dedicated application to another application program installed on the terminal apparatus 10 (here, a generic web browser). In this case, the controller 15 causes the terminal apparatus 10 to display a web page (hereinafter also referred to as the “reservation and payment page”) that provides the functionality for reservation and electronic payment for open parking lots while the web browser is running in the foreground.

The reservation and payment page is one of the web pages provided by the predetermined service provider in the present embodiment but is not limited to this example and may be a web page provided by a partner of the predetermined service provider, for example. Various buttons (such as a reservation button, payment button, and OK button) that have the same functions as those described above in step S203, for example, can be displayed on the reservation and payment page. Similar to the above-described first payment procedure, an input field (hereinafter also referred to as “third input field”) that enables the user to input information such as the time slot of use of the open parking lot and an input field (hereinafter also referred to as “fourth input field”) that enables the user to input information on the payment method can be displayed on the reservation and payment page.

After entering information in the third input field and fourth input field as appropriate, the user can tap the OK button on the reservation payment page to complete the electronic payment, on the web browser, for the open parking lot and confirm the reservation of the open parking lot. The second payment procedure of the present embodiment can thus be provided. In a case in which it is determined that the reservation and electronic payment, on the web browser, for the open parking lot have been completed, the controller 15 can determine that the electronic payment process is complete.

Any method can be employed to determine whether the reservation and electronic payment, on the web browser, for the open parking lot have been completed. For example, when it is detected that the user has tapped the OK button, data may be transmitted from the second server 30 to the first server 20 notifying that the reservation and electronic payment for an open parking lot have been completed. Hereafter, this data is also referred to as a “Payment Completion Notification”. The payment completion notification may be transmitted from the second server 30 to the terminal apparatus 10 when, for example, it is detected that the user has switched the application program running in the foreground from the web browser to the dedicated application by operating the terminal apparatus 10. In a case in which the payment completion notification is received by the terminal apparatus 10, the controller 15 of the terminal apparatus 10 can determine that the reservation and electronic payment, on the web browser, for the open parking lot have been completed.

By steps S201 through S205, the controller 15 can provide either the first payment procedure or the second payment procedure as the electronic payment procedure for the usage fee, depending on the attribute information of the open parking lot selected by the user on the map. Upon completion of the electronic payment process, the process advances to step S104 described above, and the controller 15 displays completion of reservation of the open parking lot.

As described above, the terminal apparatus 10 in the present embodiment executes the following operations according to the application program (dedicated application). The terminal apparatus 10 displays on a map, in a selectable manner, a plurality of open parking lots registered respectively by a plurality of service providers. Upon selection of an open parking lot by a user, the terminal apparatus 10 displays a usage fee for the open parking lot. Upon completion of electronic payment of the usage fee for the open parking lot, the terminal apparatus 10 displays completion of reservation of the open parking lot.

According to such a configuration, a plurality of open parking lots registered respectively by a plurality of service providers are displayed on a map in a selectable manner. Thus, for example, a user can search a plurality of open parking lots registered with different service providers and can select and reserve a desired open parking lot by executing a single dedicated application on the terminal apparatus 10. Technology for reserving open parking lots is therefore improved in that it is easier to use a single application to reserve open parking lots registered with a plurality of service providers.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, in one variation of the embodiment described above, the controller 15 of the terminal apparatus 10 may vary the appearance of each open parking lot displayed on the map according to whether a reservation can be made, whether the first payment procedure can be provided, or both. Specifically, the controller 15 may vary the appearance of the pin indicating each open parking lot displayed on the map, such as the display color of the pin, of the outline of the pin, or of both, depending on whether the open parking lot is reservable, whether the first payment procedure can be provided, or both. For example, the controller 15 may set the display color of pins for reservable open parking lots to a first color and set the display color of pins for non-reservable open parking lots to a second color different from the first color. Additionally or alternatively, the controller 15 may set the display color of the outline of the pins of open parking lots registered with a predetermined service provider (step S201) or owned by a predetermined parking lot owner (step S203) to a third color. These open parking lots are open parking lots for which the first payment procedure cannot be provided but the second payment procedure can be provided. The controller 15 may set the display color of the outline of the pins of open parking lots that do not fall into these categories and for which the first payment procedure can be provided to a fourth color that differs from the third color. The first through fourth colors can be set to any colors that are easy for the user to distinguish.

For example, an embodiment in which the first server 20 executes some of the processing that is executed by the terminal apparatus 10 in the embodiment described above can be implemented.

For example, an embodiment in which a general purpose computer functions as the terminal apparatus 10 according to the above embodiment can also be implemented. Specifically, a program (application program) in which processes for realizing the functions of the terminal apparatus 10 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. A method to be executed by a terminal apparatus according to an application program, the method comprising:
displaying on a map, in a selectable manner, a plurality of open parking lots registered respectively by a plurality of service providers;
displaying, upon selection of an open parking lot by a user, a usage fee for the open parking lot; and
displaying, upon completion of electronic payment of the usage fee for the open parking lot, completion of reservation of the open parking lot.

2. The method according to claim 1, further comprising acquiring, as attribute information for each open parking lot, information indicating whether a parking lot owner has passed a merchant screening for credit card payment.

3. The method according to claim 2, further comprising providing, as a procedure for electronic payment of the usage fee, a first payment procedure using an electronic payment function implemented in the application program or a second payment procedure using an electronic payment function implemented in a website provided by a service provider that has registered each parking lot, according to the attribute information for the open parking lot.

4. The method according to claim 3, further comprising:
acquiring provider information indicating which service provider has registered each open parking lot; and
in a case in which it is determined, based on the provider information, that the service provider that has registered the open parking lot selected by the user is a predetermined service provider, providing the second payment procedure as the procedure for electronic payment of the usage fee.

5. A non-transitory computer readable medium storing an application program configured to cause a terminal apparatus to execute operations, the operations comprising:
displaying on a map, in a selectable manner, a plurality of open parking lots registered respectively by a plurality of service providers;
displaying, upon selection of an open parking lot by a user, a usage fee for the open parking lot; and
displaying, upon completion of electronic payment of the usage fee for the open parking lot, completion of reservation of the open parking lot.
